(19) United States
(12) Patent Application Publication
(10) Pub. No.: US 2016/0125426 A1
(43) Pub. Date: May 5, 2016

(54) Determining Engagement Levels Based On Topical Interest

(71) Applicant: VIVASTREAM LLC, New York, NY (US)

(72) Inventors: Steven J. Francolla, Brooklyn, NY (US); Kyle Morehouse, Ridgefield, CT (US); Zachary D. Balson, New York, NY (US)

(21) Appl. No.: 14/531,526

(22) Filed: Nov. 3, 2014

(51) Int. Cl. G06Q 30/02

(52) U.S. Cl. CPC G06Q 30/0201; G06Q 30/0252; G06Q 30/0269

(57) ABSTRACT

The current subject matter describes generating effective personal connections and/or marketing leads based on scores computed per topic for individuals attending an event. A computing device associated with an event attendee can receive data characterizing an attendee's activity related to a topic. The computing device can send this data to a computing server connected to the computing device via a communication network. The computing server can obtain a weight associated with the activity from a database. The computing server can generate a score for one or more topics for the event attendee based on the weight. The computing server can send a recommendation based on the score(s) to at least one of a computing device of another event attendee, an entity having a marketing interest in the event, a marketing automation application, and a customer relationship management application.

### TECHNICAL FIELD

The subject matter described herein relates to determining a level of engagement (for example, interest or expertise) of an individual in one or more topics associated with one or more events. Determining an engagement level can involve generating and/or modifying one or more scores associated with an individual in relation to a specific event topic.

### BACKGROUND

Companies, corporations, businesses and the like (also referred to as enterprises) often organize, sponsor and/or participate in conferences, seminars and other events to discuss or showcase recent products, developments and happenings relevant to their fields. Statistically, more than a million such events are organized by various enterprises annually in the United States with a combined budget of more than one billion United States dollars. Events provide attendees with valuable opportunities to connect and interact with other like-minded individuals interested in the same topics and/or who have information, knowledge and resources to share. Identifying those individuals, however, among hundreds or thousands of event attendees remains difficult.

Moreover, with the advent of the Internet, social media and conference-specific applications for computers and mobile devices, terabytes of data are generated by and between individuals before, during and after an event. Enterprise executives have acknowledged the need and importance of collecting and tagging such data in an effort to extract useful information (for example, user interests or expertise) associated with event attendees for purposes of generating future marketing leads. Event attendee data, however, has traditionally been limited to registration lists of event attendees, attendance during the event, and event speaker lists. Most of this available data is often enormous in volume, but not useful. That is, the amount of recent (for example, real-time), accurate and predictive data about event attendees (for example, business professionals) and their interests that is actually available for meaningful use is minimal. Consequently, marketing departments and personnel at enterprises find parsing through such data to be challenging, demanding and, in short, ineffective in terms of generating useful marketing leads.

### SUMMARY

The subject matter described herein relates to determining the level of engagement of an event attendee in one or more event topics based on one or more scores computed per topic for the event attendee based on topical interests or topical activities. Using these one or more scores, alone or in combination with one or more other parameters, one or more connections (for example, other event attendees) can be determined and identified to an individual event attendee and/or one or more event attendees and related data can be identified and distributed to an enterprise. Related apparatuses, systems, techniques, and articles are also described.

Some implementations can include a method involving receiving, by at least one of a normalization processor, one or more software development kits, and one or more web modules within a computing server (for example, a cloud computing server), data characterizing an activity related to a topic by an individual. Method implementations can also involve sorting, by an application programming interface within the computing server, the data characterizing the activity according to topic and activity, wherein the application programming interface can be connected to the normalization processor, the one or more software development kits and/or the one or more web modules. In some implementations, the method include obtaining, by at least one data processor within the computing server and from a database within the computing server a weight associated with the activity, wherein the at least one data processor can be connected to the application programming interface and the database, and generating, by the at least one data processor and based on the weight, a score for the individual. The weight obtained by the at least one data processor can be one of a plurality of weights stored in the database that are specific for a plurality of activities that are possible by attendees of an event. The database can be a memory storage device embedded within the computing server. The generating of the score based on the weight can involve mathematically adding the weight with one or more weights of other one or more activities by the user.

The generating can include generating a summary document for the individual that displays a score and data characterizing one or more activities by the individual. Some method implementations can involve sending the summary document to a computing device of an entity that is configured to display the summary document on a graphical user interface executed by the computing device of the entity. The sending, by the at least one data processor and via a communication network, can involve sending at least one of the score and the summary document to at least one of a marketing automation application and a customer relationship management application. The summary document can be displayed on the graphical user interface of the computing device of the entity in real-time so as to, for example, characterize a minimal time difference between a first time when the data characterizing the activity is received and a second time when the summary document is displayed on the graphical user interface of the computing device of the entity.

Depending on the implementation, the at least one computing device associated with the individual can be operated by the individual and/or the at least one computing device can be an identification device that scans an identification apparatus on the individual for an identity of the individual.

In some method implementations, an individual can be scheduled to attend an event, subject matter relating to a topic can be discussed during the event and/or an entity has a marketing interest in the event.

In some implementations, at least one of the normalization processor, the one or more software development kits, and the one or more web modules can receive data characterizing activity related to a topic from at least one computing device associated with the individual.

The plurality of activities can include one or more of the individual electronically mentioning that the individual is interested in the topic, the individual electronically mentioning that the individual needs help on the topic, the individual electronically mentioning that the individual can help with the topic, the individual electronically checking into a session associated with the topic, an identification device of the individual being scanned before attending a session associated with the topic, the individual electronically commenting regarding the topic, the individual posting regarding the topic on a social networking website, the individual reposting regarding the topic, the individual electronically searching for the topic, the individual viewing an electronic presentation associated with the topic, and the individual electronically responding to one or more questions of a poll related to the topic. In some implementations, each activity of the plurality of activities can be associated with a respective weight.

Some method implementations can involve receiving, by at least one of the normalization processor, one or more software development kits and one or more web modules, data characterizing another activity related to the topic by the individual, sorting, by an application programming interface within the computing server, the data characterizing another activity according to topic and activity, obtaining, by the at least one data processor and from the database, an additional weight value associated with the another activity, modifying, by the least one data processor and based on the another weight, a score for the individual and generating, by the at least one data processor and based on the score, a new summary document for the individual, the new summary document displaying the updated score and data characterizing at least the activity and the another activity by the individual. Implementations can involve thereafter sending, by the at least one data processor and via a communication network, the new summary document to the computing device of the entity, wherein the computing device of the entity can be configured to display the new summary document on the graphical user interface. The new summary document can be displayed on the graphical user interface of the computing device of the entity in real-time, wherein the real-time can characterize a minimal time difference between a first time when the data characterizing another activity is received and a second time when the new summary document is displayed on the graphical user interface of the computing device of the entity.

In some method implementations, at least one of the normalization processor, the one or more software development kits and the one or more web modules can receive the data characterizing the activity related to the topic by the individual immediately after the activity occurs. Implementations can involve monitoring, by the at least one data processor, time elapsed since the computing server receives the data characterizing the activity, comparing, by the at least one data processor, the time elapsed since the computing server receives the data characterizing the activity with a threshold value specific to the activity, decrementing, by the at least one data processor, the score when the time elapsed since the computing server receives the data characterizing the activity is less than the threshold value and sending, by the at least one data processor and via a communication network, the decremented score to the computing device of the entity, the computing device configured to display the decremented score on the graphical user interface. The at least one data processor can receive the threshold value specific to the activity from the database to perform the comparing, the database storing a plurality of threshold values, wherein each threshold value of the plurality of threshold values can be specific to a corresponding activity of a plurality of activities that are possible by attendees of an event.

Some implementations can be directed to a non-transitory computer program product storing instructions that, when executed by at least one programmable processor, cause the at least one programmable processor to perform operations, including receiving (for example, at a computing device of an entity) a score for an individual from a computing server connected to the computing device of the entity via a communication network. The score can be generated by the computing server based on a weight associated with an activity that is associated with the individual and is related to a topic. In some implementations, the instructions when executed can involve displaying (for example, on a graphical user interface of the computing device of the entity) the score along with scores of other individuals. In some implementations, an entity may have a marketing interest in an event and/or an individual can be an event attendee of the event.

Some method implementations can involve receiving (for example, by a computing device operated by an event attendee of an event) data characterizing activity related to a topic by the event attendee and sending (for example, by a computing device operated by an event attendee and via a first communication network) data characterizing the activity related to the topic to a computing server connected to the computing device operated by the event attendee. The computing server can obtain a weight associated with the activity from a database of the computing server, generate a score for the event attendee based on the weight and/or send data characterizing a recommendation regarding the event attendee based on the score to a computing device of an entity having a marketing interest in the event. The computing device of the entity can be connected to a computing server via a second communication network. In some implementations, a first communication network can be the same as a second communication network or, alternatively, a first communication network can be different from a second communication network. The computing server, according to some implementations, can generate data characterizing a recommendation before sending the recommendation to a computing device of an entity having a marketing interest in the event, wherein the computing server can generate the data characterizing the recommendation when the score is more than a predetermined threshold value.

Computer program products are also described that comprise non-transitory computer readable media storing instructions, which when executed by at least one data processors of one or more computing systems, causes at least one data processor to perform operations herein. Similarly, computer systems are also described that can include one or more data processors and a memory coupled to the one or more data processors. The memory can temporarily or permanently store instructions that cause at least one processor to perform one or more of the operations described herein. In addition, methods can be implemented by one or more data processors either within a single computing system or distributed among two or more computing systems.

The subject matter described herein provides many advantages. For example, the score generated per topic for an event attendee is a fairly accurate indicator of an interest of the event attendee in the topic. Such accuracy allows an enterprise to streamline marketing activities targeted toward this individual in order to increase sales. Moreover, the software application allows event attendees of similar interests to connect with each other, and event attendees seeking help on a topic to seek help from those willing to offer help on that topic. Thus, the software application described herein can be beneficial for both: entities (for example, organizers of an event) that have a marketing interest in the event, and event attendees seeking to connect with other event attendees having similar interests.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating various individuals performing one or more activities associated with an event that they are scheduled to attend according to some aspects of the disclosure;

FIG. 2 is a system diagram illustrating a system that determines levels of engagement and generates marketing leads based on interests of individuals in various topics associated with an event according to some aspects of the disclosure;

FIG. 3 is a diagram illustrating a graphical user interface of a software application displaying a profile of an individual with respect to an event according to some aspects of the disclosure;

FIG. 4 is a diagram illustrating a graphical user interface of a software application displaying a profile of an event according to some aspects of the disclosure;

FIG. 5 is a diagram illustrating a graphical user interface of a software application displaying a profile of an individual attending an event according to some aspects of the disclosure;

FIG. 6 is a diagram illustrating a graphical user interface of a software application that is displayed when an individual selects or searches for a particular topic;

FIG. 7 is a system diagram illustrating a system that generates a level of engagement score per topic for an individual who is scheduled to attend, is currently attending or has attended an event according to some aspects of the disclosure;

FIG. 8 is a diagram illustrating a graphical user interface of a software application that displays level of engagement scores per topic for an individual who is scheduled to attend, is currently attending or has attended an event according to some aspects of the disclosure;

FIG. 9 is a diagram illustrating a graphical user interface of a software application that displays an individual's statistics for a specific topic based on activities engaged in by the individual that relate to that topic and for which a computing server has already generated the score according to some aspects of the disclosure;

FIG. 10 is a diagram illustrating a graphical user interface of a software application that displays specific activities engaged in by an individual that relate to a specific topic and for which a computing server has already generated the score according to some aspects of the disclosure;

FIG. 11 is a diagram illustrating a graphical user interface of a software application that displays an aggregation of topic-specific statistics derived from individuals attending an event according to some aspects of the disclosure;

FIG. 12 is a flow diagram illustrating generation of a score and a summary document by a computing server according to some aspects of the disclosure;

FIG. 13 is a diagram illustrating a database including topic-based activities and topical weights associated with those activities according to some aspects of the disclosure;

FIG. 14 is a flow diagram illustrating an adjustment of a topic or level of engagement score based on one or more topic-specific activities occurring since the last score was generated according to some aspects of the disclosure;

FIG. 15 is a diagram illustrating a graphical user interface of displaying a summary of topic score and/or related activities of the individual according to some aspects of the disclosure; and

FIG. 16 is a diagram illustrating a graphical user interface of displaying details of topic-specific activities of an individual according to some aspects of the disclosure.

When practical, like reference symbols in the various drawings indicate like elements.

### DETAILED DESCRIPTION

Implementations of the subject matter described herein can be directed to an online event platform or activity engine (for example, a server, such as a cloud computing server; and also referred to as a system) that can continuously monitor the activities and conversations of event attendees (including event speakers) in real-time. In some implementations, the platform can be configured to monitor and analyze interests and event activities (for example, attendance to a specific event session) of an individual based on topic (for example, cloud computing topic) and identify other event attendees to that individual based on shared topical interests and expertise. Implementations of the platform can ensure that a trending topic at an event is identified to any individual that demonstrates an interest in that topic as determined by his/her event activities, conversations and the like (for example, viewing an event's website or online profiles of other event attendees). In some implementations, the platform can inform an individual who to know (for example, people whom the individual can connect with or benefit from) at an event based on the individual's interests, online profile and noted skills and help that individual connect and interact with one or more other event attendees with matching interests, skills or expertise before, during and after an event.

Some implementations can be directed to collecting and categorizing (for example, in real time) interest, behavioral and activity data of event attendees (for example, before, during or after an event) and turning that data into insights that can be analyzed and acted upon to generate marketing leads for enterprises that are hosting, sponsoring and/or participating in an event or whom are simply in the same field as one or more topics associated with an event. Platform implementations according to the present subject matter can collect signals (for example, an event attendee liking (for example, electronically showing interest in) a topic or checking into an event session on a specific topic), aggregate and organize the signals (for example, by activity type), weight and score the signals by topic (for example, determine a numerical value of how engaged/interested a user is in a particular topic), generate insights by topic (for example, a particular individual is extremely interested in the cloud computing topic), provide real-time analytical data for each topical insight (for example, a summary and detailed activity record for an individual for one or more topics) and distribute results to one or more enterprises. In some implementations, the topical insight results by pushed (for example, transmitted or made available) to one or more marketing entities (for example, customer relationship management entities or marketing automation entities) associated with or operating on behalf of an enterprise. Some implementations can involve providing enterprises with a topic-based interface (for example, a graphical dashboard or any other online control panel) to view generated topical insights relating to any event as they occur in real-time.

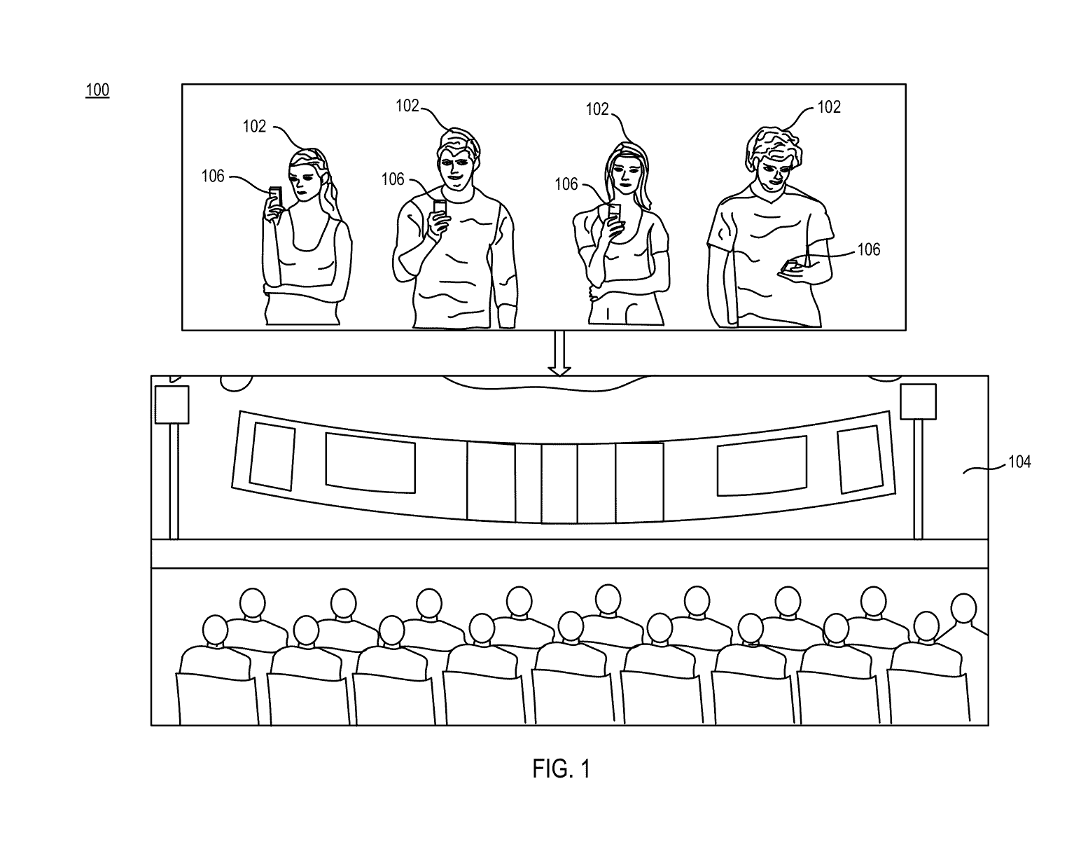

FIG. 1 is a diagram 100 illustrating various individuals (also referred to as users herein) 102 performing activities associated with an event 104 that they are scheduled to attend. The individuals 102 can perform these activities on a software application executed on respective computing devices 106, such as one or more of a desktop computer, a laptop computer, a tablet computer, a phablet computer, a cellular phone, and/or any other computing device. The event 104 can be at least one of a conference, a seminar, a workshop, a class, a product launch party, shareholder meeting, and any other event. The activities can include registering for the event 104 and showing interest in one or more topics (for example, by viewing an event session concerning a specific topic) associated with the event 104. Based on interests of the individuals 102 in any topic associated with the event 104, one or more personal connections and/or marketing leads associated with that topic can be generated, as described in more detail below. The term topic discussed herein can also be referred to as a subject, area, product, focus, issue, theme, matter, and/or the like.

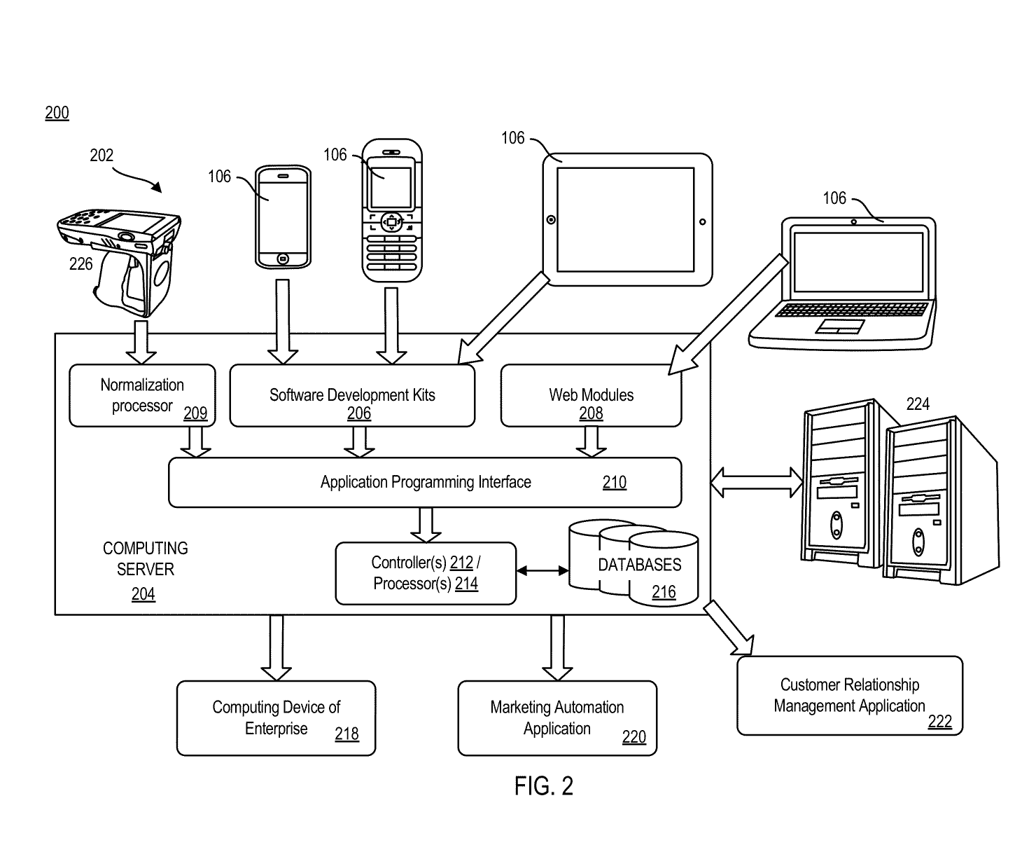

FIG. 2 shows a system 200 according to an implementation of the disclosure that can include a system 202 that generates personal connections and/or marketing leads based on interests, behaviors and/or activities of individuals 102 with respect to one or more topics associated with an event. The system 202 includes a computing server 204 that can include one or more software development kits 206, one or more web modules 208, one or more normalization processors 209, one or more application programming interfaces 210, one or more controllers 212 having one or more processors 214, and one or more databases 216 connected to the one or more controllers 212.

In some implementations, at least one of the one or more software development kits 206, the one or more web modules 208, and the one or more normalization processors 209 can receive data that characterizes one or more activities (for example, action(s), conduct, behavior(s)) being engaged in by an individual 102 and which relate to one or more topics associated with an event. The data can be received from a computing device (e.g., computing device 106) of the individual 102. The at least one computing device 106 from which the computing server 204 can receive data that characterizes or relates to one or more activities of an individual 102 can include the computing device 106 itself and/or an identification device 226 that can scan for attendance of the individual 102. In one example, the identification device 226 can be a radio frequency identification (RFID) device.

The one or more software development kits 206 can receive the data that characterizes or relates to activity of an individual 102 when the individual 102 engages in or performs one or more activities using a computing device 106 that is a cellular phone or mobile device. In some implementations, the one or more web modules 208 can receive data that characterizes or relates to activity of an individual 102 when the individual 102 engages in or performs one or more activities using a web browser on a computing device 106. In some implementations, the one or more normalization processors 209 can be configured to automatically extract data from various external sources (for example, device 226, as described below).

In some implementations, one or more application programming interfaces 210 can receive data (for examples, one or more signals) that characterizes or relates to one or more activities (for example, a user is scanned using an RFID device) of an individual 102. That data can include activity (for example, attendance of a user, as detected by scanning performed by an RFID device), a scope (for example, the event), data characterizing an actor (for example, the user), and data characterizing a topic (for example, cloud computing topic). The one or more application programming interfaces 210 can be, for example, a Hypertext Transfer Protocol (HTTP) server that receives the data (for example, one or more signals) at a uniform resource identifier (URI). The activity data within this data can be indicated by a text parameter within such URI.

In some implementations, the data can be sorted according to topic or type of activity. For example, the one or more application programming interfaces 210 can process the data received at the URI for other data. In some implementations, that data (for example, one or more signal messages) can be structured text, such as JavaScript Object Notation (JSON). For example, a minimum requirement structure of the data can include an event name attribute, user attributes (for example, first name, last name, job or company), topic attributes (for example, topicName1, topicName2, . . . topicNameN) or context attributes (for example, a description of words/phrases). In some implementations, the one or more application programming interfaces 210 and/or processors 214 can parse or sort the data to identify one or more minimum criteria required to persist an activity about a topic for a user. In some implementations, parsing can be performed on one or more context attributes to identify the relevant topics by, for example, searching across a context attribute's structure values for topic phrases, which in some implementations, can be preconfigured by a user.

In some implementations, the multiple data points (for example, a plurality of signals) can be aggregated/collected into a single representation. For example, once minimum criteria are identified, received data (for example, data characterizing activity, scope, actor, and topic) can be processed and translated into a view that is comprehensible by a user (for example, reducing data to a score, a small descriptive paragraph or a list of granular activity detail). In some implementations, the one or more application programming interfaces 210 and/or processors 214 can predict future data (for example, data scores and activity detail) based on prior behavior by, for example, incorporating predictive analytics. Examples of aggregated data according to some implementations include a continually-compounded event-user-topic strength score or a continually-updated event-user-topic summary paragraph.

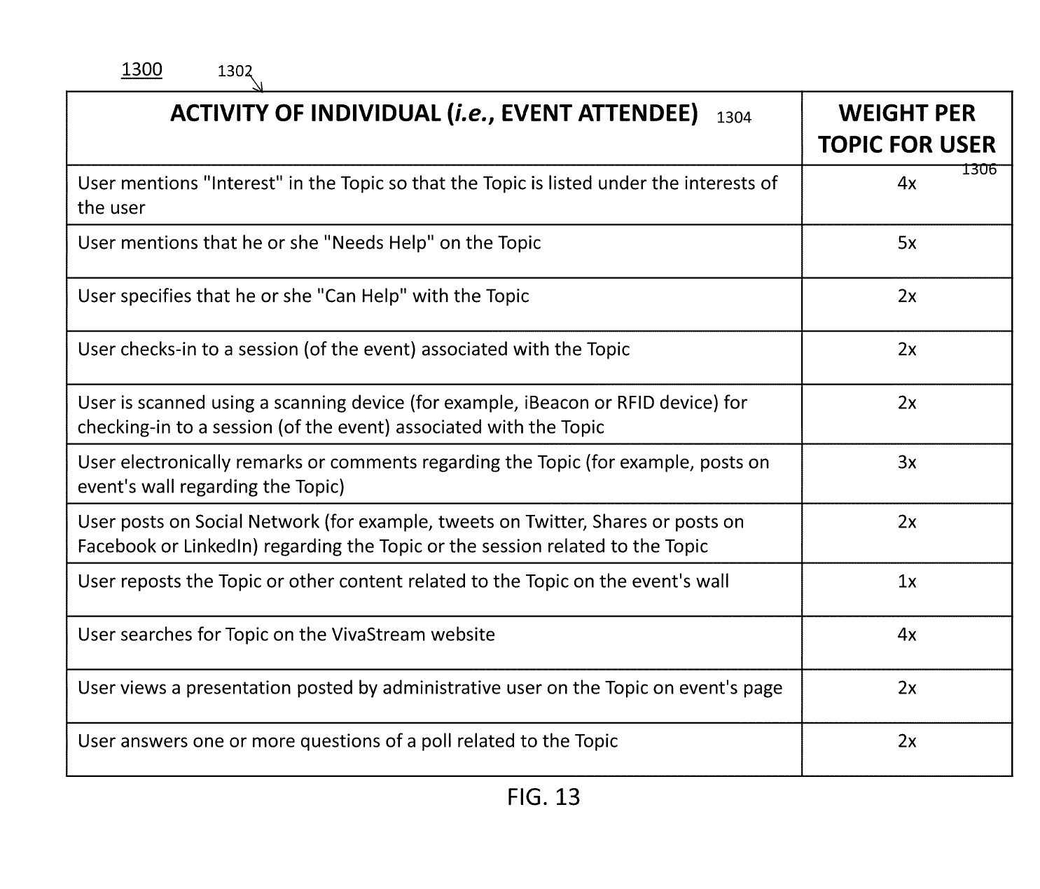

The one or more processors 214 can receive the data sorted and/or aggregated according to topic and activity type from one or more of the application programming interfaces 210 and thereafter retrieve a weight (for example, a predetermined or preprogrammed unique value, such as five) assigned to a particular activity type engaged in by or relating to the individual 102. In some implementations, activity types (for example, a user is scanned using an RFID device) and assigned or associated weights can be stored in a database 1302 (described below with respect to diagram 1200 discussed below) of the one or more databases 216. Database 1302, according to some implementations, can store a plurality of unique weight values specific to various types of activities engaged in by attendees of any event. (see FIG. 13) An activity type can be weighted relative to other activity types, as explained below with respect to FIG. 13. Examples of event activities that can be accorded one or more unique weight values according the present disclosure can include one or more of: the individual 102 electronically mentioning, on a software application executing on computing device 106, that the individual 102 is interested in a specific topic; the individual electronically mentioning, on a software application executing on computing device 106, that the individual 102 needs help with a specific topic; the individual 102 electronically mentioning, on a software application executing on computing device 106, that the individual 102 can help with a specific topic; the individual 102 electronically checking-in, on a software application executing on computing device 106, to an event session associated with a specific topic; an identification device of the individual 102 being scanned by identification device 226 before attending an event session associated with a specific topic; the individual 102 electronically commenting regarding a specific topic on a software application executed on the computing device 106; the individual posting regarding a topic on a social networking website, such as TWITTER, FACEBOOK, LINKEDIN, and/or any other social networking website; the individual 102 reposting regarding a topic on a software application executing on computing device 106; the individual 102 electronically searching for a topic on or using a software application executing on computing device 106; the individual 102 viewing, on or via a software application executing on computing device 106, an electronic presentation associated with a specific topic; the individual 102 electronically responding, on a software application executing on computing device 106, to one or more questions of a poll related to a specific topic; and other similar or related activities. Each activity can be associated with a respective weight.

Subsequently, based on one or more weight values associated with one or more activities, the one or more processors 214 can generate a score (for example, a numeric value, such as forty) for an individual 102 that relates to a particular topic (for example, cloud computing topic). In some implementations, weight can be considered as being the amount of weight accrued for each activity associated with a particular topic. More specifically, a score for a particular topic can be derived based on a mathematical sum of two or more weights associated with two or more corresponding activities detected for an individual 102 for a topic (for example, when a weight of ten for a user is determined based on scanning using an RFID device and a weight of fifteen is calculated based on “views a presentation” activity and when both these activities relate to the cloud computing topic, the total score can be twenty five for the cloud computing topic for the individual). In some implementations, a generated score for a topic can be added to a user's existing score for that same topic (for example, using the example above, if the individual interested in the cloud computing topic already has an existing score of thirty five for this cloud computing topic, the score of twenty five for the two additional activities discussed above will result in a score of sixty for the cloud computing topic for that individual). In other words, as new activity is registered, a score can be adjusted by the product of the number of instances of each particular activity and the weight defined for that activity.

In one alternate implementation, the score of an individual 102 for a particular first topic can be further influenced by activities of the individual 102 specific to topics related to the first topic. In one example, the one or more processors 214 can compute the score of an individual for cloud computing based on activities of the individual associated with cloud computing, as well as based on activities for other topics related to cloud computing, such as application programming interfaces topic, databases topic, and so on. The one or more processors 214 can define related topics as all other topics (besides the first topic, such as the cloud computing topic) that along with the first topic are each a sub-topic of a common parent topic. Thus, in this alternate implementation, the score of an individual for a particular topic can be influenced by topics related to the particular topic.

In yet another alternate implementation, the score of an individual per topic, as computed by the one or more processors 214, can be further influenced by interactions of the individual with other individuals. For example, if the individual 102 electronically follows another individual, the score of the individual 102 can be further increased. In another example, if the individual 102 performs a conversation with another individual via an electronic message, the one or more processors 214 can implement natural language processing techniques to determine keywords associated with the topic and further increase the score based on the conversation in the message. In some implementations, the another individual referred to in this paragraph can be one who has a score on the topic that is higher than a predetermined threshold (for example, when this another individual is an expert). Thus, in this alternate implementation, the score of an individual for a particular topic can be influenced based on scores of other users and/or interactions with those users.

In one implementation, the one or more processors 214 can compute the score of an individual for all topics combined rather than only per topic. For example, the score of an individual can be based on all activities performed by the user for all topics. Such a collective score can characterize an engagement of the individual with the system.

The one or more processors 214 can use one or more generated scores and/or one or more activities associated with an individual 102 to generate a summary document (for example, a summary report) for the individual 102. In some implementations, a summary document can show a score per topic, an engagement level (for example, interested, very interested, extremely interested, and the like) of the individual 102 in a topic based on the score and/or the activities of the individual 102. In some implementations, level of engagement can be determined based on the percentile rank of a user's score for a given topic. For example, a user with a topic score that falls within a particular range (for example, the top two deciles) can be assigned a specific engagement level (for example, extremely interested) for that particular topic. A user with a topic score in a different range (for example, in the next two deciles) can be assigned a different level of engagement (for example, very interested).

The one or more processors 214 can retrieve, from the one or more databases 216, data that characterizes or relates to one or more distribution partners and distribution rules stored in the one or more databases 216. The one or more distribution partners can be the entities (for example, entities implementing one or more of a computing device 218 of an entity (for example, an event organizer of the event) that may have a marketing interest in the event, a marketing automation application 220, and a customer relationship management application 222) to whom the summary document can be sent. The distribution rules can include rules used to determine timings for sending this summary document to the one or more distribution partners. In some implementations, the one or more databases 216 can be a memory, such as a random access memory, of the one or more controllers 212.

The one or more processors 214 can send, for example via a communication network and based on the data characterizing the one or more distribution partners and the distribution rules, a summary document to one or more of a computing device 218 of an entity (for example, an event organizer or sponsor of the event) that may have a marketing interest in the event, a marketing automation application 220, and a customer relationship management application 222. In some implementations, the one or more processors 214 can send a summary document to these external systems when a score for an individual 102 for a particular topic exceeds a predetermined threshold value for that particular topic. In some implementations, the predetermined threshold value can be same for each topic; and in alternate implementations, the predetermined threshold value can be different for two or more topics (and for each topic, in other implementations). In some implementations, the one or more processors 214 can send a summary document to these external systems in real-time (for example, while an event is occurring). The computing device 218 of the entity can display a summary document on a user interface device of computing device 218. Computing device 218 can display the summary document as soon as it receives the summary document from the one or more processors 214.

The computing server 204 can be a cloud computing server that can be controlled by one or more servers 224 via a querying language, such as structured query language (SQL). The one or more servers 224 can be configured to be operated only by authorized users with authorized access to these one or more servers 224.

In some implementations at least one of the one or more software development kits 206, the one or more web modules 208, and the one or more normalization processors 209 can receive data that characterizes additional activities (for example, one of the activities noted above) being engaged by the individual 102 after an initial topic score based on previous activity has been generated by the one or more processors 214. Having received such additional data, the one or more processors 214 can obtain and/or identify one or more additional unique weight values associated with this additional activity from the database 1302 (described below). The one or more data processors 214 can modify one or more topic scores for the individual 102 based on these additional unique weight values and corresponding activities. For example, a modified score for a particular topic can be derived based on a mathematical sum of the weights of each additional activity detected for an individual 102 for the topic as described above.

If the modified score is more than a predetermined threshold value associated with a topic (e.g., greater than seventy five), the one or more data processors 214 can generate a summary document that mentions the modified score, an engagement level of the individual 102 based on the modified score, and/or the activities of the individual 102. The computing server 204 can send the summary document to a computing device 218 of an entity, to which computing server 204 had earlier sent a version of a score. The computing device 218 of the entity can display the summary document on the user interface device. In some implementations, a computing device 218 of an entity can display the summary document in real-time. This real-time can characterize a minimal time difference between a time when the data characterizing another activity is received and a subsequent time when the summary document is displayed on the user interface device of the computing device 218 of the entity.

In some implementations, the computing server 204 can receive data that characterizes or relates to one or more activities of an individual 102 relating to a specific topic in real-time (that is, immediately after the activity occurs). In some implementations, one or more processors 214 can monitor the time elapsed from when a computing server 204 received the data and calculate a most-recent version of the score and generate a summary document mentioning the most-recent version of the score, an engagement level of the individual 102 in that topic based on the score, and/or the activities of the individual 102 with respect to that topic.

In some implementations, one or more data processors 214 can conversely monitor an individual's inactivity or lack of interest with respect to a particular topic by comparing the time elapsed since computing server 204 received data associated with that topic against a threshold value and, thereafter, automatically decrementing the individuals' score for that topic when the elapsed time is less than the threshold value. In some implementations, the threshold value can be predetermined or preexisting and/or specific to a particular activity. If the decremented score is less than a predetermined threshold value for the topic, the computing server 204 can send, via a communication network, another summary document mentioning the decremented score, an engagement level of the individual 102 for the topic based on the score, and/or the activities of the individual 102 with respect to the topic to a computing device 218 of an entity, to which the computing server 204 had earlier sent a most recent version of the summary document. This user interface device of the computing device 218 can display the summary document mentioning the decremented score and/or the activities of the individual 102.

The one or more data processors 214 can receive the threshold value specific to the activity from a database of the one or more databases 216. Each threshold value of the plurality of threshold values stored in this database can be specific to a corresponding activity of a plurality of activities that are possible by attendees of an event.

The controllers 212 described herein can be microcontrollers. The processors 214 described herein can be computing processors, such as microprocessors. The one or more databases 216 can include a plurality of databases including a non-transitory computer/machine readable media and/or non-transitory computer program product. The communication network described herein can include a local area network, a wide area network, internet, intranet, Bluetooth network, infrared network, and/or other communication networks. The computing device 218 of the entity can be one or more of: a desktop computer, a laptop computer, a tablet computer, a phablet computer, a cellular phone, and/or any other computing device. Some examples of the marketing automation application 220 can be MARKETO and ELOQUA. A few examples of the customer relationship management application 222 can be SALESFORCE, MICROSOFT DYNAMICS, and SUGARCRM.

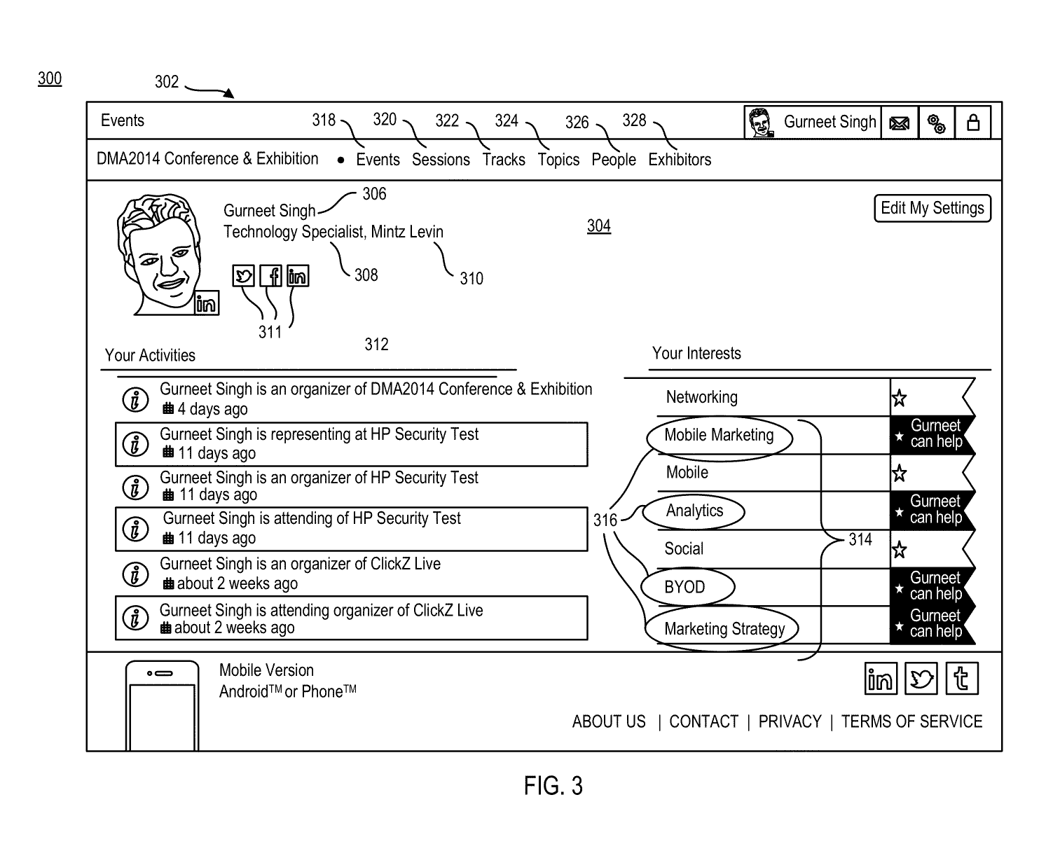

FIG. 3 is a diagram 300 illustrating a graphical user interface 302 of a software application according to implementations of the disclosure displaying a profile 304 of an individual 102. The user interface device of computing device 106 executes the graphical user interface 302. Profile 304 of individual 102 can display a name 306 of individual 102, a title 308 and/or an employer 310 of individual 102, one or more links 311 to profiles of individual 102 on respective one or more social networking websites (for example, TWITTER, FACEBOOK, LINKEDIN, and/or the like), activities 312 performed by individual 102, one or more topics 314 that individual 102 has selected in order to express interest in them, one or more topics 316 that individual 102 has selected and can help others in, and/or other data associated with the individual 102.

The activities 312 can include registering for the event and showing interest in various topics associated with the event. The activities 312 can further include one or more of: the individual 102 electronically mentioning, on a software application executing on the computing device 106, that the individual 102 is interested in one or more topics; the individual electronically mentioning, on a software application executing on the computing device 106, that the individual 102 needs help on a topic; the individual 102 electronically mentioning, on a software application executing on the computing device 106, that the individual 102 can help with a topic; the individual 102 electronically checking-in, on a software application executing on the computing device 106, to a session associated with a topic; an identification device of the individual 102 being scanned by the identification device 226 before attending an event session associated with a topic; the individual 102 electronically commenting regarding a topic on a software application executing on the computing device 106; the individual posting regarding the topic on a social networking website, such as TWITTER, FACEBOOK, LINKEDIN, and/or any other social networking website; the individual 102 reposting regarding a topic on a software application executing on the computing device 106; the individual 102 electronically searching for a topic on a software application executing on the computing device 106; the individual 102 viewing, on a software application executing on the computing device 106, an electronic presentation associated with a topic; the individual 102 electronically responding, on a software application executing on the computing device 106, to one or more questions of a poll related to a topic; and other similar or related activities. In some implementations, the individual 102 can change settings such that only selective types of activities are displayed to the individual 102 and/or other individuals (for example, other event attendees).

The individual 102 can add topics 314 in which the individual 102 is interested to the profile 304. To add a topic of interest to the profile 304, the individual 102 can search the topic using a search tool provided in the software application, and then add the searched topic to the profile 304. The individual 102 can also delete a topic 314 from the profile 304.

In some implementations, the individual 102 can access a plurality of events where the individual 102 can connect with other individuals that are interested in similar or the same topics 314 of interest. For example, the individual 102 can access a webpage showing a profile of a particular event the individual 102 is interested in, as described by diagram 400 discussed below. On the webpage of this particular event, the individual 102 can access (for example, visit the profile of) other attendees of this event. The individual 102 can access a profile of any of these other attendees, as described by diagram 500 discussed below. Based on the profile of another attendee that shows topics of interest for this other attendee and topics in which this other attendee can help, the individual 102 can decide whether to connect with this attendee. Further, the individual 102 can also search for a topic associated with this event to obtain search results, including event attendees interested in this topic and event attendees who can help with this topic, as described by diagram 600 discussed below.

The graphical user interface 302 can display an event link 318, a sessions link 320, a tracks link 322, a topics link 324, a people link 326 and/or an exhibitors link 328. When the individual 102 selects the event link 318, the one or more processors 214 can generate and send, for display to the computing device 106 of the individual 102, a graphical user interface 402 (discussed below) that shows data characterizing at least the following: the event browsed by the individual 102; data characterizing names, titles, and links to profiles of attendees planning to attend the event; and a wall (which can also be referred to as a stream) for the event.

When the individual 102 selects the sessions link 320, the one or more processors 214 can generate and send, for display to the computing device 106 of the individual 102, a graphical user interface that displays data characterizing various sessions in the event being browsed by the individual 102, such as: name of each session; date and time for each session; venue/location for each session; a list of filters (for example, topics and other generally searched data, such as “Keynotes,” “1:1 Gurus,” “Ask the Experts,” “B2B Symposium” and the like) that can be used to search for relevant sessions from the list of sessions; and a link next to each session that allows the individual 102 to add the session to his/her agenda or calendar.

When the individual 102 selects the tracks link 322, the one or more processors 214 can generate and send, for display to the computing device 106 of the individual 102, a graphical user interface that displays various events filtered according to the entity (for example, the host company) organizing the event, and a link to sessions for each of those events.

When the individual selects the topics link 324, the one or more processors 214 can generate and send, for display to the computing device 106 of the individual 102, a graphical user interface that displays: a graphical display of a predetermined number of (for example, three) topics with the most interest currently (which can also be referred to as hottest topics), a number of attendees who are interested in each of these hottest topics, and a number of attendees who can help with each of these hottest topics; and a list of all the topics, a number of sessions associated with each of the topics in this list, a number of attendees who can help with each of these topics, a number of attendees who are interested in each of these topics, and a number of exhibitors associated with each of these topics.

When the individual 102 selects the people link 326, the one or more processors 214 can generate and send, for display to the computing device 106 of the individual 102, a graphical user interface that displays a list of all the people registered to access various conferences, and links to the profiles of those people.

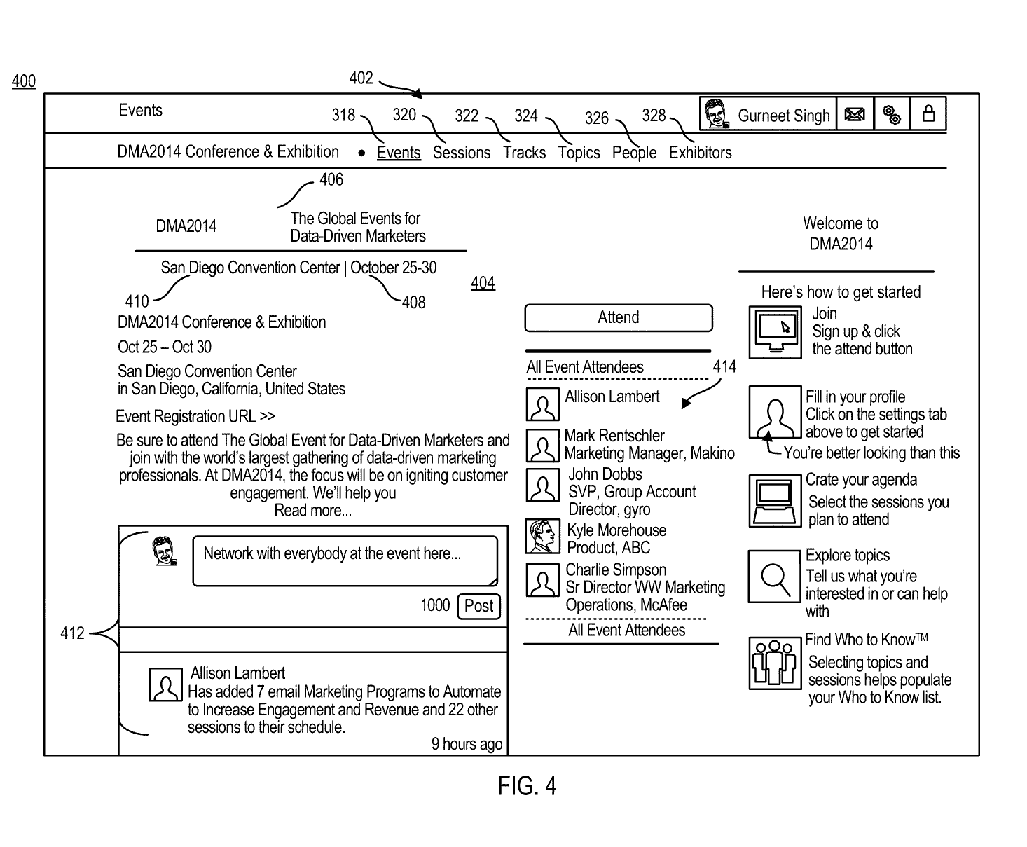

When the individual 102 selects the exhibitors link 328, the one or more processors 214 can generate and send, for display to the computing device 106 of the individual 102, a graphical user interface that displays all the exhibitors that have either exhibited in events in the past or have registered for exhibiting in the future. FIG. 4 is a diagram 400 illustrating a graphical user interface 402 of the software application displaying a profile 404 of an event. The user interface device of the computing device 106 executes the graphical user interface 402. The profile 404 of the event can include a name 406 of the event, one or more dates 408 for the event, a location 410 of the event, a wall (which can also be referred to as a stream) 412 for the event where event attendees can post, and a list 414 of event attendees that have registered so far. In one implementation, the posts on the wall 412 can be displayed to only the event attendees. In an alternate implementation, the posts on the wall 412 can be displayed to anyone registered with the software application. In yet another alternate implementation, the posts on the wall 412 can be displayed publically to any individual regardless of whether the individual is registered with the software application. Such display preferences can be controlled by authorized users by operating the one or more servers 224.

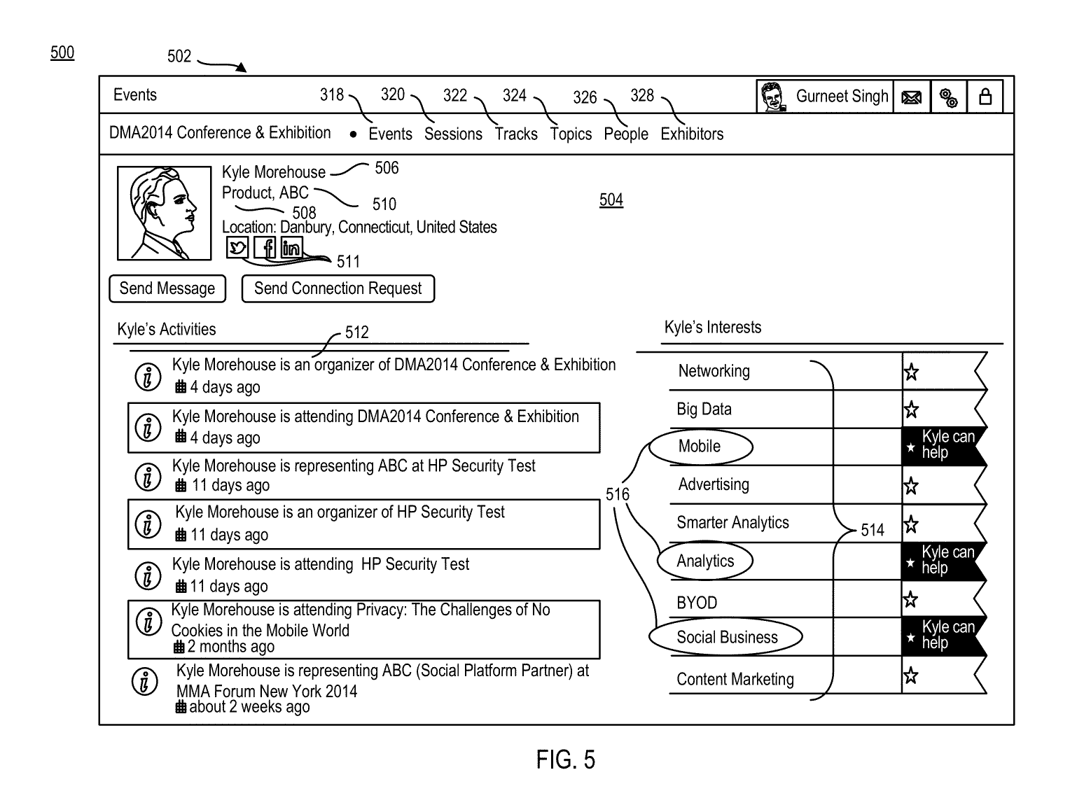

FIG. 5 is a diagram 500 illustrating a graphical user interface 502 of the software application displaying a profile 504 of another individual (for example, another event attendee), for example, as viewed by the individual 102. The user interface device of the computing device 106 executes the graphical user interface 502. The profile 504 of this another event attendee can include one or more of: a name 506 of this event attendee, a title 508 and/or employer 510 of this event attendee, one or more links 511 to profiles of this event attendee on respective one or more social networking websites (for example, TWITTER, FACEBOOK, LINKEDIN, and/or the like), activities 512 performed by this event attendee, one or more topics 514 that this event attendee has selected in order to express interest in them, one or more topics 516 that this event attendee has selected and can help others in, and/or other data associated with this event attendee. Based on the profile 504 of this event attendee, the individual 102 can decide whether to connect with this attendee at the event, prior to the event, and/or after the event.

The activities 512 can include registering for the event and showing interest in various topics associated with the event. The activities 512 can further include one or more of: this event attendee electronically mentioning, on the software application, that this event attendee is interested in a topic; the individual electronically mentioning, on the software application, that this event attendee needs help on a topic; this event attendee electronically mentioning, on the software application, that this event attendee can help with a topic; this event attendee electronically checking-in, on the software application, to a session associated with a topic; an identification device of this event attendee being scanned by the identification device 226 before attending a session associated with a topic; this event attendee electronically commenting regarding a topic on the software application; this event attendee posting regarding the topic on a social networking website, such as TWITTER, FACEBOOK, LINKEDIN, and/or any other social networking website; this event attendee reposting regarding a topic on the software application; this event attendee electronically searching for a topic on the software application; this event attendee viewing, on the software application, an electronic presentation associated with a topic; this event attendee electronically responding, on the software application, to one or more questions of a poll related to the topic; and other similar or related activities. In some implementations, this event attendee can change settings such that only selective types of activities are displayed to other individuals (for example, other event attendees).

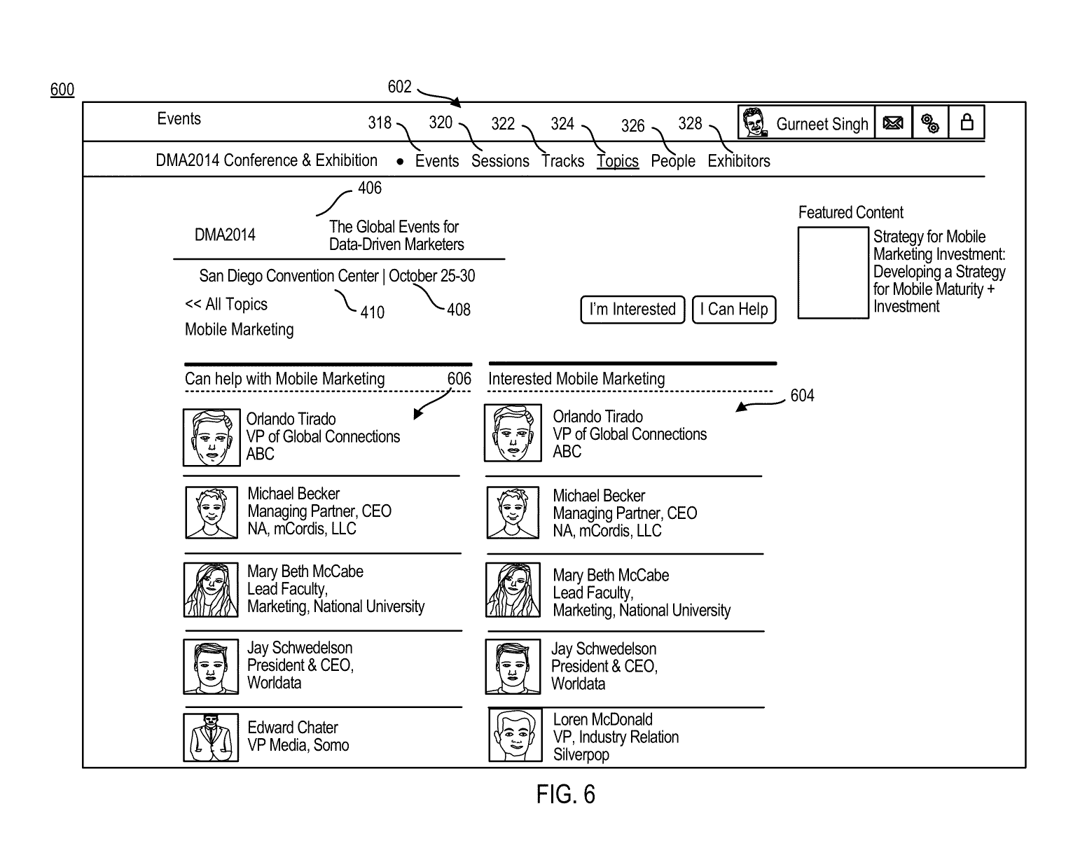

FIG. 6 is a diagram 600 illustrating a graphical user interface 602 of the software application that is displayed when the individual 102 selects or searches for a particular topic. The graphical user interface 602 displays selection results or search results including: a list 604 of event attendees who have mentioned or otherwise indicated (for example, by selecting an icon) that they are interested in that topic and a list 606 of event attendees who have mentioned or otherwise indicated (for example, by selecting an icon) that they can help with that topic. In some implementations, the event attendees in lists 604 and/or 606 can be ordered in terms of most relevant to individual 102 to least relevant to the individual 102. In some implementations, the ordering of lists 604 and/or 606 can be performed based on user-to-user complement scoring in real-time or near real-time, which can involve identifying a set of topic strength scores of a user and whether a user has indicated as being a topical expert.

The graphical user interface 602 can display individuals, which have indicated in their profiles that they are interested in a particular topic (for example, mobile marketing, as shown in the diagram), in the list 604 in a ranked order that is generated based on scores per topic (for example, the mobile marketing topic, shown in the diagram) for each listed individual. That is, the individual displayed first and at the top of the list 604 has the highest score among all the individuals in the list 604, meaning that such individual has indicated (for example, by attending the most event sessions, posting a comment about a particular topic and/or viewing content about a particular topic that s/he has the greatest interest and/or expertise in that particular topic relative to all other individuals on the list and/or other event attendees. Conversely, the individual displayed at the bottom of the list 604 has the lowest score among all the individuals in the list 604, meaning that such individual has indicated (for example, by attending less or no event sessions, not posting a comment about a particular topic and/or not viewing content about a particular topic that s/he has the least (or no) interest and/or expertise in that particular topic relative to all other individuals on the list and/or other event attendees.

In some implementations, the order of individuals displayed in the list 604 can be based on recency (that is, how recent), namely meaning that the last person to select the topic can be listed at the top of the list. In some implementations, the order of individuals displayed in the list 604 can be based on each individual's topic strength, that is, score for a particular topic. In some implementations, if a first user engages in an activity relating to a topic, or otherwise selects that topic, while a second user is viewing a list 604 for that topic, the first user can be added to the top of the list 604 that the second user is viewing, for example, based on recency. In some implementations, when the second refreshes list 604, the order of individuals on list 604 can revert to rank order by topic score, moving the first user to a different position in list 604.

The graphical user interface 602 can display individuals, which have indicated in their profiles that they can help with the particular topic (for example, mobile marketing, in the shown diagram), in the list 606 in a ranked order generated based on scores per topic (for example, the mobile marketing topic, shown in the diagram) for these individuals. That is, the individual displayed first and at the top of the list 606 has the highest score among all the individuals in the list 606, meaning that such individual has indicated (for example, by attending the most event sessions, posting a comment about a particular topic and/or viewing content about a particular topic that s/he has the greatest interest and/or expertise in that particular topic relative to all other individuals on the list and/or other event attendees. Conversely, the individual displayed at the bottom of the list 606 has the lowest score among all the individuals in the list 606, meaning that such individual has indicated (for example, by attending less or no event sessions, not posting a comment about a particular topic and/or not viewing content about a particular topic that s/he has the least (or no) interest and/or expertise in that particular topic relative to all other individuals on the list and/or other event attendees.

The individual 102 can select any event attendee of the displayed event attendees in lists 604 and/or 606 to see a profile of the selected individual.

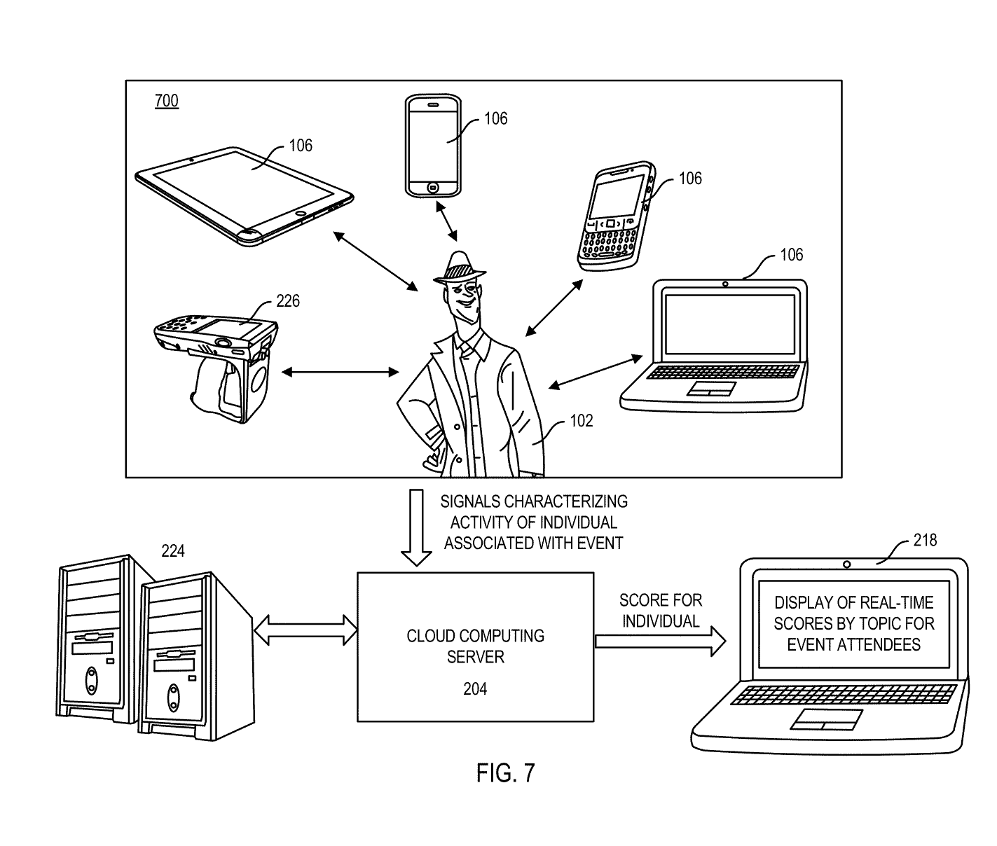

FIG. 7 is a system diagram 700 illustrating a system 702 that generates scores per topic for individuals 102 that are scheduled to attend, are attending or have attended an event. The scores per topic for the individuals 102 can be displayed in real-time by a computing device 218 of an entity (for example, an enterprise organizing the event) that may have a marketing interest in the event. A description of this generation and display of the score follows. The computing server 204 can receive data characterizing one or more activities being engaged in by an individual 102 before, during and/or after an event that relates to one or more specific topics associated with an event. The computing server 204 can derive or obtain a unique weight value associated with each of the one or more activities from a database 1302 (described below) of the one or more databases 216 identified above with respect to FIG. 2.

Subsequently, based on the unique weight value associated with each of the one or more activities, the computing server 204 can generate a unique score value (also referred to as the score) for the individual 102. In one example, a score per topic can be a mathematical sum of the weights of each activity detected for an individual 102 for the topic, as described in detail above.

The computing server 204 can generate a summary document that can identify the score, an engagement level (described below) of the individual 102 for the topic based on the score, and/or the activities of the individual 102. The computing server 204 can then send, via a communication network, this summary document to the computing device 218 of the entity. The computing device 218 of the entity can display the summary document on a user interface device of this computing device 218 in real-time. The computing server 204 can modify the score and the summary document when more data associated with one or more additional activities that relate to a topic on the summary document is received and when there is a significant change in recency of the previous activities contributing to the score, as described above. The computing server 204 can then send the modified summary document to the computing device 218, which can then display the modified summary document. The computing device 218 can display the modified summary document in place of the previous summary document.

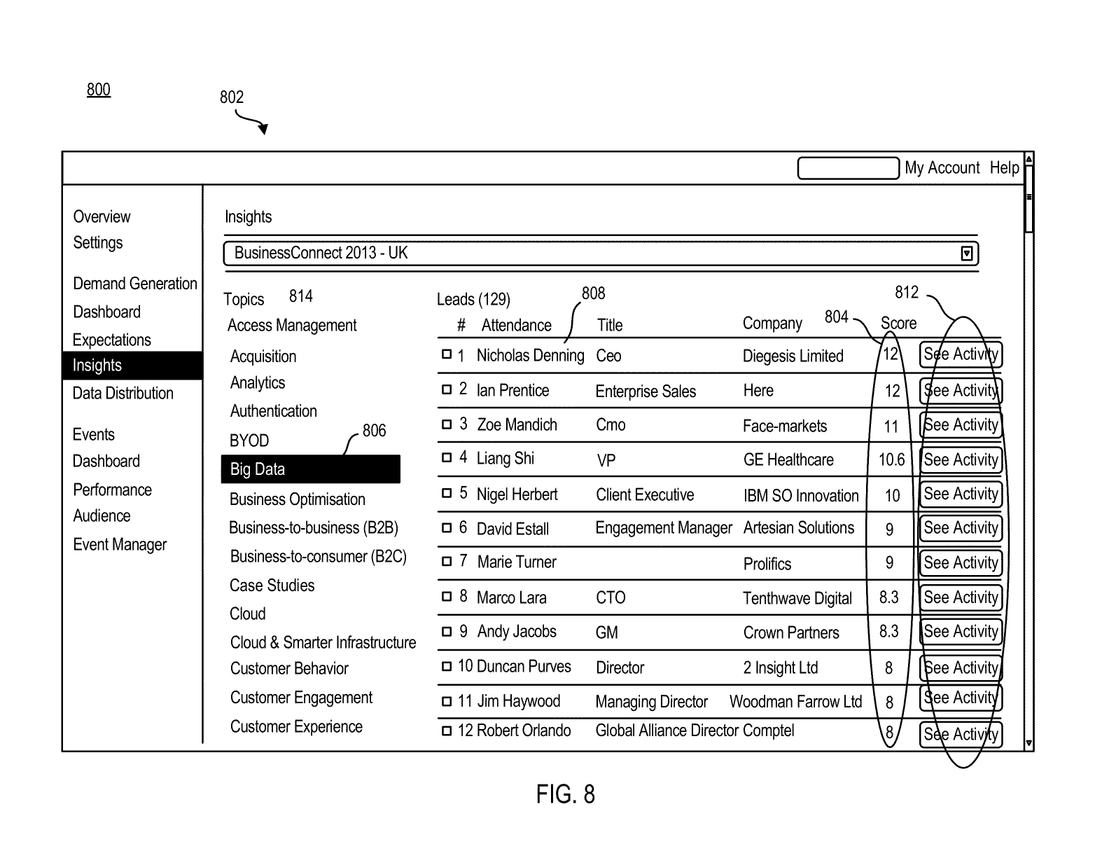

FIG. 8 is a diagram 800 illustrating a graphical user interface 802 that displays scores 804 per topic 806 (for example, Big Data topic) for individuals (more specifically, event attendees) 808 associated with an event 810 (for example, “BusinessConnect 2013—UK” conference). The computing server 204 can generate the graphical user interface 802 and send the data characterizing the graphical user interface 802 to a user interface device of the computing device 218 of the entity, which can then execute/display the graphical user interface 802. The graphical user interface 802 can display buttons/links 812 for the individuals (for example, event attendees) 808. An authorized user of the entity can select any button 812 to view: statistics associated with activity of the individual 808 (which can be the same as the activity of this individual 808 as shown on his/her profile) associated with the selected button 812 (as described by diagram 900 discussed below), and/or activity of this individual 808 (as described by diagram 1000 discussed below). The authorized user of the entity can view the scores for event attendees associated with any other topic 814 by clicking on that topic 814.

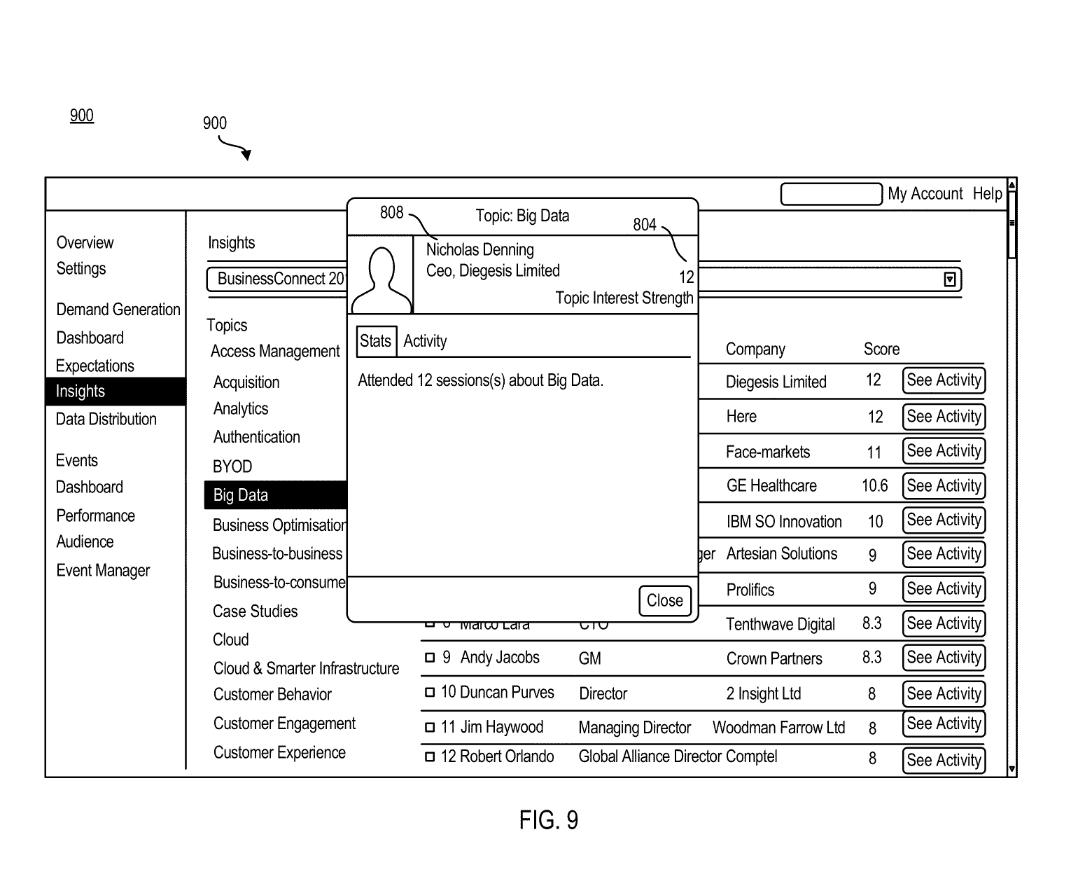

FIG. 9 is a diagram 900 illustrating a graphical user interface 902 of the software application that displays statistics (for example, a “Stats” tab indicating “Attended 12 session(s) about Big Data”) associated with activity of an individual 808 for whom the computing server 204 has already generated a score 804 for a particular topic. The user interface device of the computing device 218 of the entity can execute the graphical user interface 902. The software application can display the graphical user interface 902 after the individual 102 selects the button/link 812 for a particular individual 808 on the graphical user interface 802.

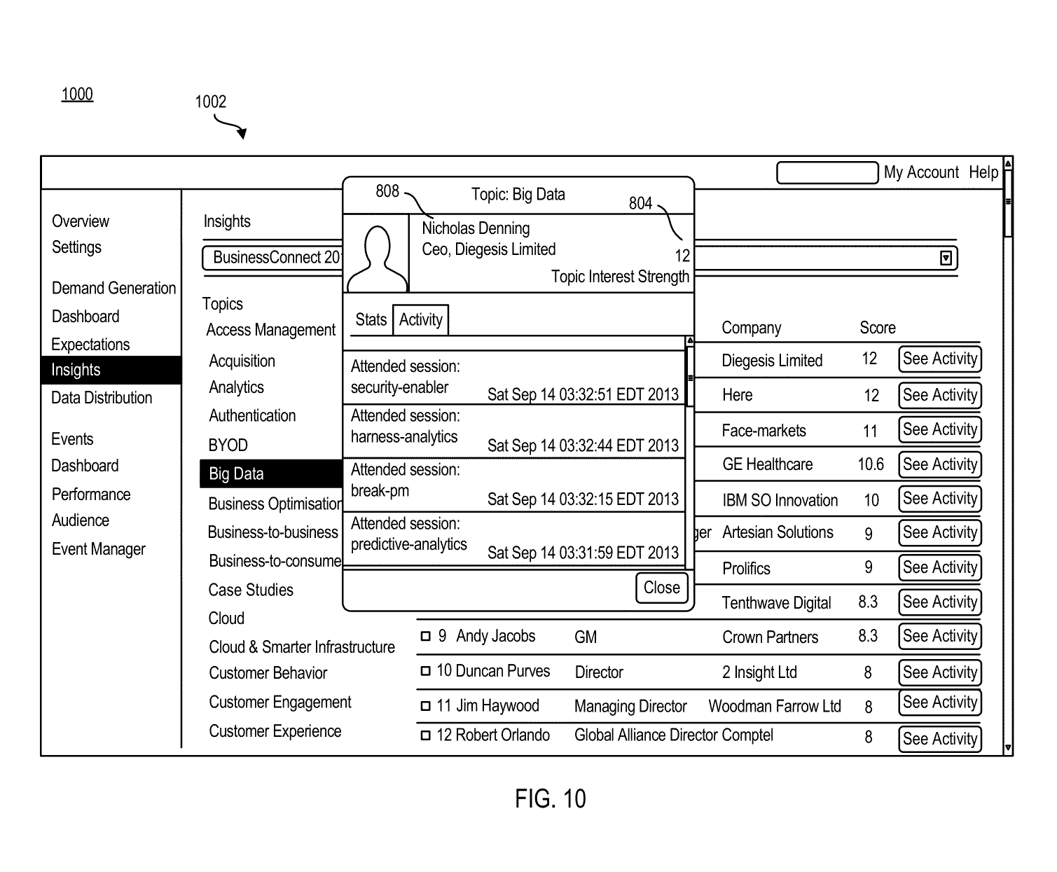

FIG. 10 is a diagram 1000 illustrating a graphical user interface 1002 of the software application that displays activity (for example, an “Activity” tab identifying attended sessions) of an individual 808 for whom the computing server 204 has already generated a score 804 for a particular topic. The user interface device of the computing device 218 of the entity can execute the graphical user interface 1002. The software application displays the graphical user interface 1002 after the individual 102 selects the button/link 812 for a particular individual 808 on the graphical user interface 802.

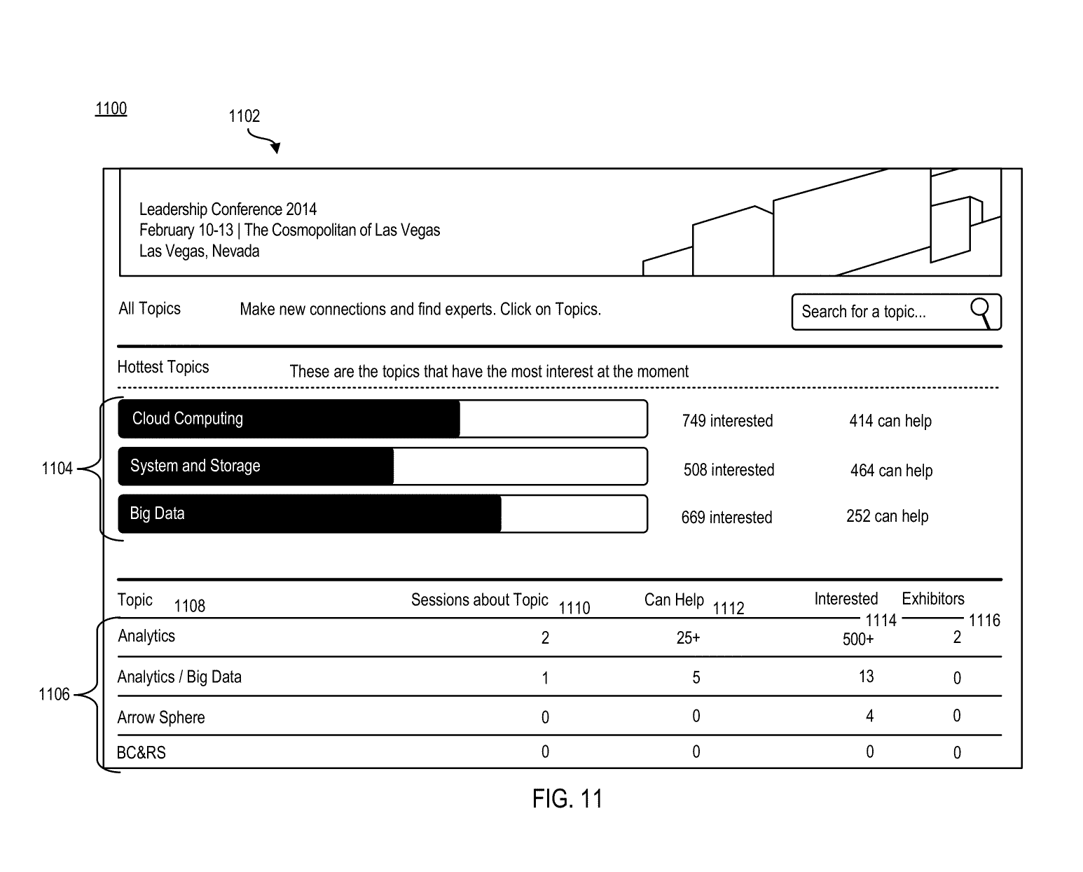

FIG. 11 is a diagram 1100 illustrating a graphical user interface 1102 of the software application that displays statistics associated with multiple topics associated with an event. The at least one data processor 214 of the computing server 204 can generate the graphical user interface 1102, and then send the data characterizing the graphical user interface 1102 to the computing device 218 of the entity. The computing device 218 of the entity can then execute/display the graphical user interface 1102. The graphical user interface 1102 can display a graphical horizontal bar chart 1104 displaying a predetermined number (for example, three, as shown in diagram 1100) of the most popular (also referred to as hottest) topics. For each topic of these displayed, most-popular topics, the horizontal bar chart 1104 can indicate: a number of event attendees that have indicated on their respective profiles that they are interested in the topic, and a number of event attendees that have indicated on their respective profiles that they can help in the topic. The graphical user interface 1102 can further display a table 1106 showing topics 1108 associated with or relevant to the event, a number of sessions 1110 about each topic in the event, a number of event attendees 1112 for each topic that have indicated on their respective profiles that they can help in the topic, a number of event attendees 1114 for each topic that have indicated on their respective profiles that they are interested in the topic, and a number of exhibitors 1116 for each topic.

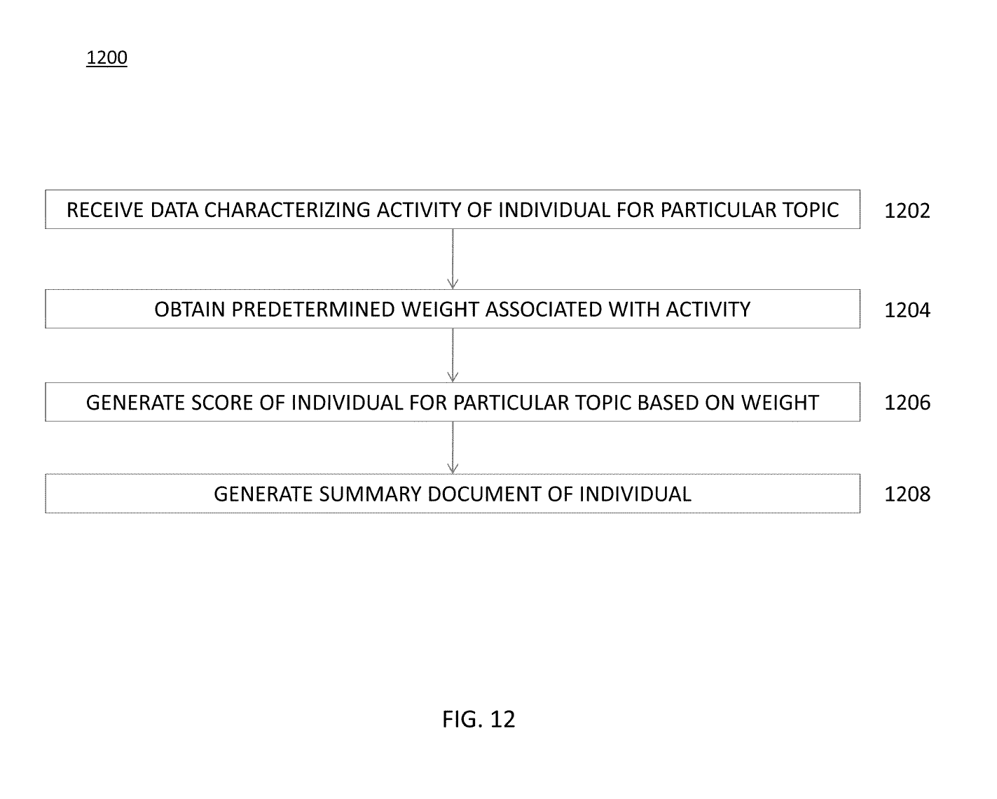

FIG. 12 is a flow diagram 1200 illustrating the collection, scoring and distribution by the computing server 204 (for example, in real-time) of unique score values and associated activities (for example, in a summary document) of an individual 102 relating to a specific topic associated with an event. The computing server 204 can collect and/or receive, at step 1202, event data (for example, in real-time) that characterizes or relates to one or more activities being engaged in by an individual 102, as previously described above with respect to FIG. 2. According to some implementations, computing server 204 can sort the collected/received data (for example, in real-time) as previously described above with respect to FIG. 2.

The computing server 204 can then derive or obtain, at step 1204, a unique weight value associated with the activity from a database 1302 (described below) of the one or more databases 216. Based on the unique weight value associated with the activity, the computing server 204 can generate, at step 1206, a score for the individual 102 as previously described above with respect to FIG. 2.

The computing server 204 can use the score to generate a summary document that shows the score and/or activities of the individual 102, as indicated at 1208 in FIG. 12. The computing server 204 can then send, via a communication network, the summary document or just the score to one or more of: a computing device 218 of an entity, a marketing automation application 220, and/or a customer relationship management application 222. The computing device 218, the marketing automation application 220, and/or the customer relationship management application 222 can display the summary document or the score.

FIG. 13 is a diagram 1300 illustrating a portion of a database (for example, a database table) 1302 including example activities 1304 and unique weight values 1306 associated with those activities 1302. The “x” in the unique weight values 1306 can be a variable, which can have any value set by operators of the one or more servers 224. The one or more databases 216 can include database 1302. After the computing server 204 receives data characterizing an activity related to a topic by an individual 102, the computing server 204 can then obtain a unique weight value 1306 associated with the activity from the database 1302. Based on the unique weight value 1306 associated with the activity 1304, the computing server 204 can generate a score for the individual 102.

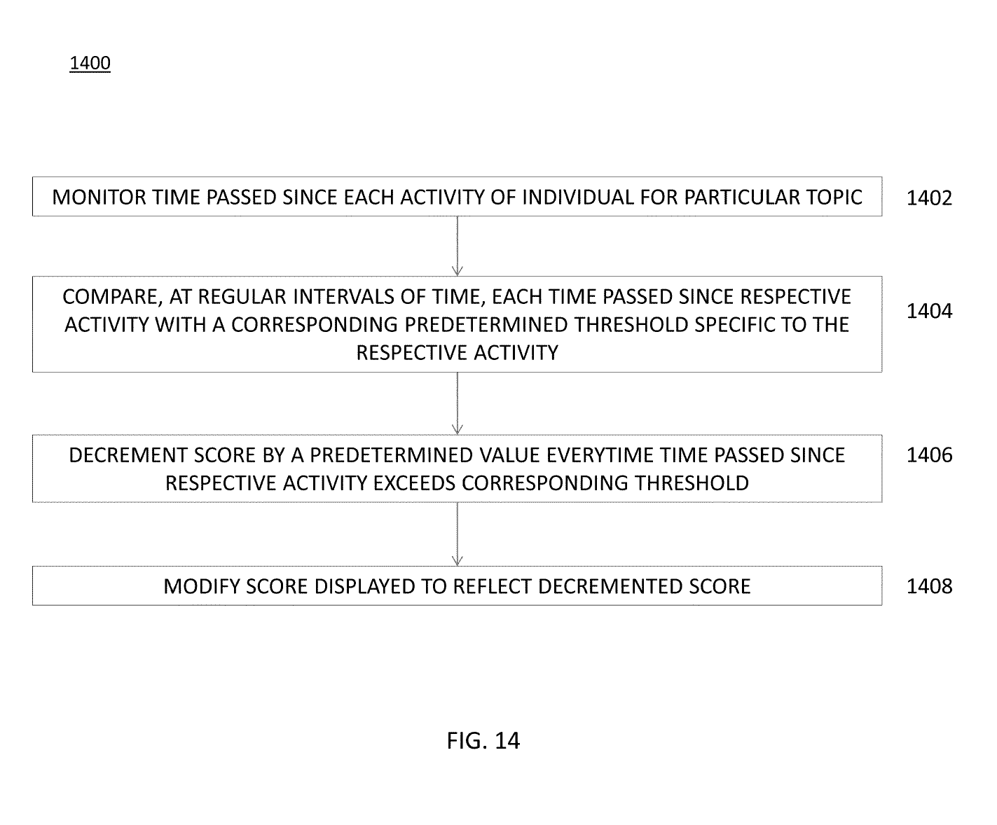

FIG. 14 is a flow diagram 1400 that illustrates adjusting a topic score of an individual 102 due to, for example, inactivity or perceived lack of interest in one or more scored topics of the individual. In some implementations, an adjustment of a topic score can be derived based on time elapsed since the last topic score was generated by the computing server 204. The computing server 204 can receive data characterizing one or more activities related to the topic of the individual 102 in real-time (that is, immediately after the activity occurs). Reception of the data can be completed, analyzed and processed in at least the same manner as described in FIG. 12 with respect to step 1202. The computing server 204 can monitor, at 1402, the time elapsed since the computing server 204 received data characterizing a particular activity of the individual 102 that it used to calculate the most recent version of the topic score. The computing server 204 can compare, at 1404, this time elapsed with a threshold value specific to the particular activity. In some implementations, the computing server 204 can decrement, at 1406, the topic score when the value of this time elapsed is less than the threshold value specific to the particular activity. The computing server 204 can send, via a communication network, the decremented score to the computing device 218 of the entity, to which the computing server 204 had earlier sent a most recent version of the score. This user interface device of the computing device 218 can display, at 1408, the decremented score in place of the previous version of the score.

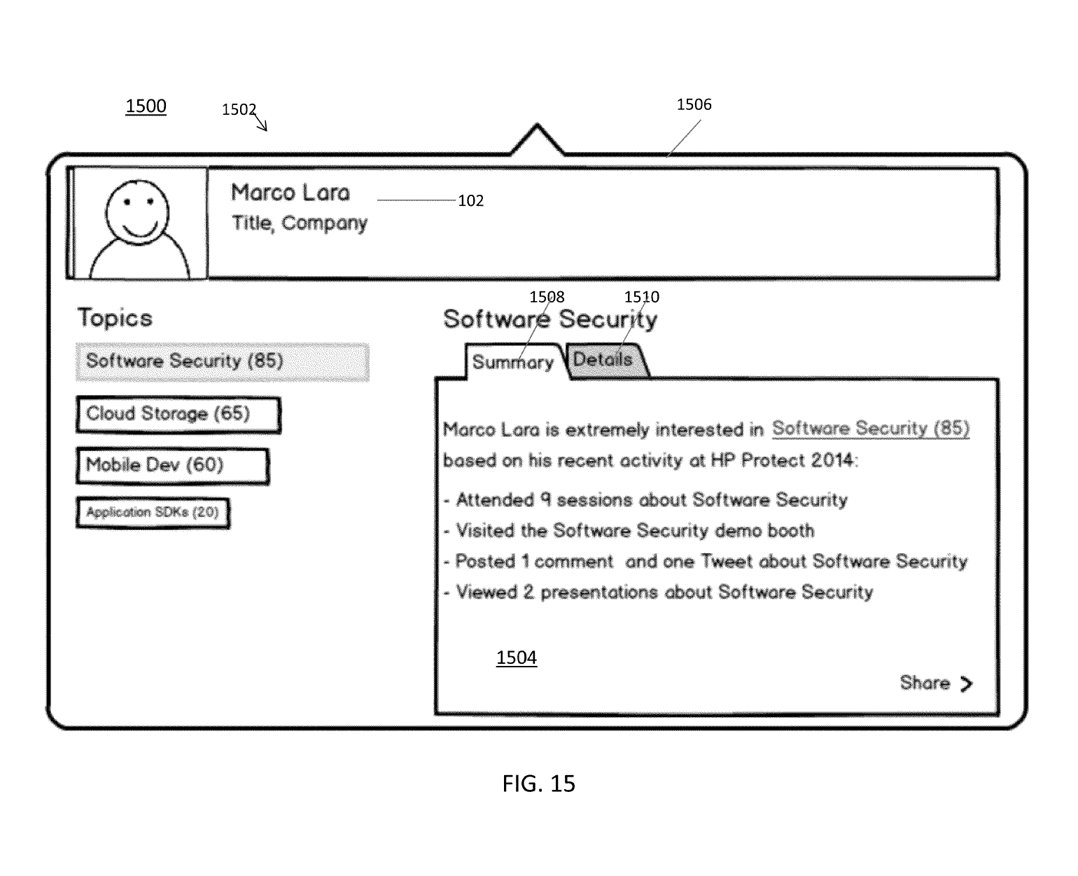

FIG. 15 is a diagram 1500 illustrating a graphical user interface 1502 of a marketing automation application 220 and/or a customer relationship management (CRM) application 222 when displaying a summary 1504 of a topic score and/or activities of an individual 102. The marketing automation application 220 and/or the CRM application 222 can display the graphical user interface 1502 after the receiving the summary document from the computing server 204. The graphical user interface 1502 displays a summary document 1506 for the individual 102 (for example, Marco Lara in the diagram 1500). The summary document 1506 can display a score for each topic (for example, a score of eighty five for software security topic, a score of sixty five for cloud storage topic, a score of sixty for mobile development topic, and a score of twenty for applications software development kits topic) associated with the individual 102, and a summary 1504 when a user selects a summary tab 1508. The summary 1504 can include an engagement level for the topic (for example, “extremely interested” in the software security topic) based on the score, and a summary of activities of the individual 102. The summary document 1506 can display details 1604 (discussed below with respect to diagram 1600) of score and/or activities of the individual 102 when the user selects the details tab 1510.

As described above, the summary 1504 mentions the engagement level of the individual 102 in a topic. The computing server 204 can determine this engagement level based on the score for this topic for the individual 102. In the shown example, the summary 1504 mentions that the individual 102 is extremely interested in the software security topic. The computing server 204 determines the engagement level to be extremely interested based on the score of eighty five in this example. Based on a score range within which the score of the individual for a particular topic lies, the engagement level can be any one of: interested, very interested, and/or extremely interested. In other implementations, other examples are also possible that characterize an interest of the individual 102 in a particular topic.

The graphical user interface 1502 can also display other topics the individual 102 is interested in (including very interested in and extremely interested in) and the score of the individual 102 for each of those other topics. In this example, the individual 102 (that is, Marco Lara) is interested in the cloud storage topic and has a corresponding score of sixty five, is interested in mobile development topic and has a corresponding score of sixty, and is interested in application software development kits (SDKs) topic and has a corresponding score of twenty. The graphical user interface 1502 allows a user to select one of these other topics in order to view summary and details for the selected topic.

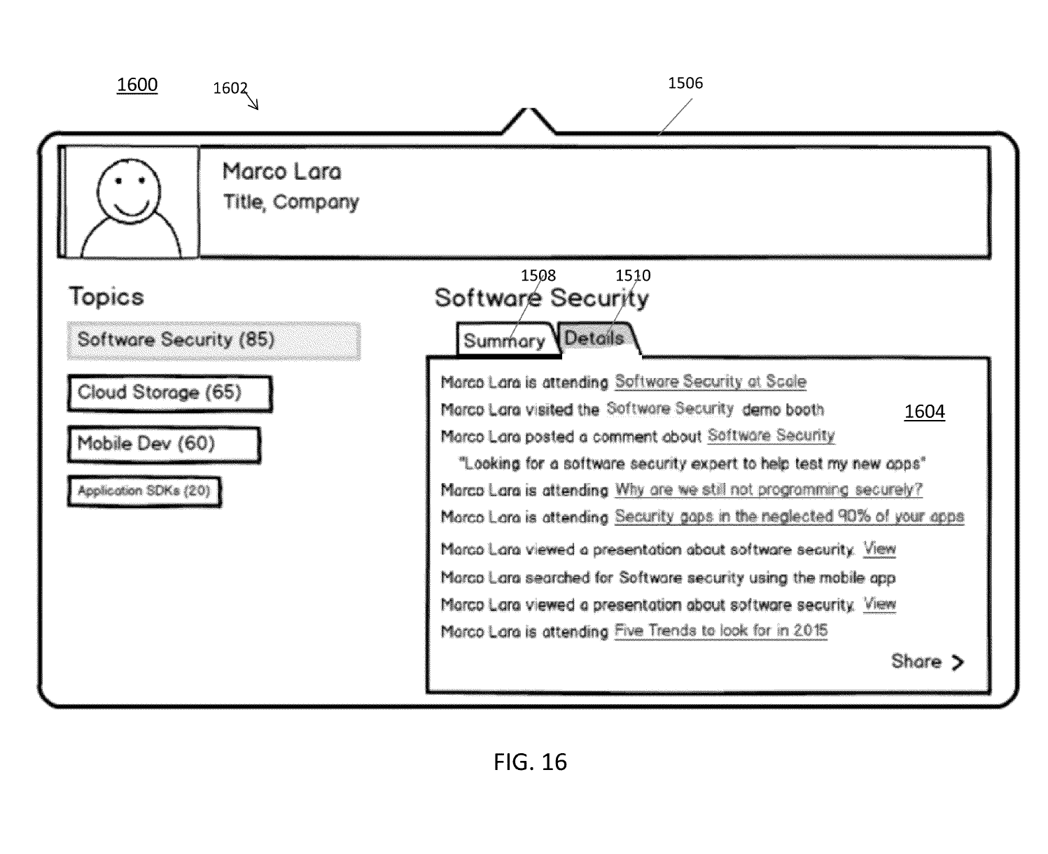

FIG. 16 is a diagram 1600 illustrating a graphical user interface 1502 of a marketing automation application 220 and/or a customer relationship management (CRM) application 222 when displaying details 1604 of score and/or activities of the individual 102. The details 1604 can display a detailed list of activities by the individual 102. The graphical user interface 1502 can display details 1604 when a user selects the details tab 1510.

Various implementations of the subject matter described herein can be realized/implemented in digital electronic circuitry, integrated circuitry, specially designed application specific integrated circuits (ASICs), computer hardware, firmware, software, and/or combinations thereof. These various implementations can be implemented in one or more computer programs. These computer programs can be executable and/or interpreted on a programmable system. The programmable system can include at least one programmable processor, which can have a special purpose or a general purpose. The at least one programmable processor can be coupled to a storage system, at least one input device, and at least one output device. The at least one programmable processor can receive data and instructions from, and can transmit data and instructions to, the storage system, the at least one input device, and the at least one output device.

These computer programs (also known as programs, software, software applications or code) can include machine instructions for a programmable processor, and can be implemented in a high-level procedural and/or object-oriented programming language, and/or in assembly/machine language. As can be used herein, the term “machine-readable medium” can refer to any computer program product, apparatus and/or device (for example, magnetic discs, optical disks, memory, programmable logic devices (PLDs)) used to provide machine instructions and/or data to a programmable processor, including a machine-readable medium that can receive machine instructions as a machine-readable signal. The term “machine-readable signal” can refer to any signal used to provide machine instructions and/or data to a programmable processor.

To provide for interaction with a user, the subject matter described herein can be implemented on a computer that can display data to one or more users on a display device, such as a cathode ray tube (CRT) device, a liquid crystal display (LCD) monitor, a light emitting diode (LED) monitor, or any other display device. The computer can receive data from the one or more users via a keyboard, a touchscreen, a mouse, a trackball, a joystick, or any other input device. To provide for interaction with the user, other devices can also be provided, such as devices operating based on user feedback, which can include sensory feedback, such as visual feedback, auditory feedback, tactile feedback, and any other feedback. The input from the user can be received in any form, such as acoustic input, speech input, tactile input, or any other input.

The subject matter described herein can be implemented in a computing system that can include at least one of a back-end component, a middleware component, a front-end component, and one or more combinations thereof. The back-end component can be a data server. The middleware component can be an application server. The front-end component can be a client computer having a graphical user interface or a web browser, through which a user can interact with an implementation of the subject matter described herein. The components of the system can be interconnected by any form or medium of digital data communication, such as a communication network. Examples of communication networks can include a local area network, a wide area network, internet, intranet, Bluetooth network, infrared network, or other networks.

The computing system can include clients and servers. A client and server can be generally remote from each other and can interact through a communication network. The relationship of client and server can arise by virtue of computer programs running on the respective computers and having a client-server relationship with each other.

Although a few variations have been described in detail above, other modifications can be possible. For example, the logic flows depicted in the accompanying figures and described herein do not require the particular order shown, or sequential order, to achieve desirable results. Other implementations or embodiments may be within the scope of the following claims.

What is claimed is:

1. A method comprising:
receiving, by at least one of a normalization processor, one or more software development kits, and one or more web modules within a computing server, data characterizing an activity related to a topic by an individual;
sorting, by an application programming interface within the computing server, the data characterizing the activity according to topic and activity, the application programming interface connected to the normalization processor, the one or more software development kits, and the one or more web modules;
obtaining, by at least one data processor within the computing server and from a database within the computing server, a weight associated with the activity, the at least one data processor connected to the application programming interface and the database; and
generating, by the at least one data processor and based on the weight, a score for the individual.

2. The method of claim 1, further comprising:
generating, by the at least one data processor and based on a value of the score, a summary document for the individual, the summary document displaying the score and data characterizing one or more activities by the individual.

3. The method of claim 1, further comprising:
sending, by the at least one data processor and via a communication network, the summary document to a computing device of an entity, the computing device of the entity configured to display the summary document on a graphical user interface executed by the computing device of the entity.

4. The method of claim 3, wherein the summary document is displayed on the graphical user interface of the computing device of the entity in real-time, the real-time characterizing a minimal time difference between a first time when the data characterizing the activity is received and a second time when the summary document is displayed on the graphical user interface of the computing device of the entity.

5. The method of claim 3, wherein:
the individual is scheduled to attend an event;
subject matter related to the topic is discussed during the event; and
the entity has a marketing interest in the event.

6. The method of claim 1, wherein the computing server is a cloud computing server.

7. The method of claim 1, wherein at least one of the normalization processor, the one or more software development kits, and the one or more web modules receives the data characterizing activity related to the topic from at least one computing device associated with the individual.

8. The method of claim 7, wherein the at least one computing device associated with the individual is operated by the individual.

9. The method of claim 7, wherein the at least one computing device is an identification device that scans an identification apparatus on the individual for an identity of the individual.

10. The method of claim 1, wherein the weight obtained by the at least one data processor is one of a plurality of weights stored in the database that are specific for a plurality of activities that are possible by attendees of an event.

11. The method of claim 10, wherein:
the plurality of activities comprise one or more of: the individual electronically mentions that the individual is interested in the topic, the individual electronically mentions that the individual needs help on the topic, the individual electronically mentions that the individual can help with the topic, the individual electronically checks-in to a session associated with the topic, an identification device of the individual is scanned before attending a session associated with the topic, the individual electronically comments regarding the topic, the individual posts regarding the topic on a social networking website, the individual reposts regarding the topic, the individual electronically searches for the topic, the individual views an electronic presentation associated with the topic, and the individual electronically responds to one or more questions of a poll related to the topic; and
each activity of the plurality of activities is associated with a respective weight.

12. The method of claim 10, wherein the database is a memory storage device embedded within the computing server.

13. The method of claim 1, wherein the generating of the score based on the weight comprises mathematically adding the weight with one or more weights of other one or more activities by the user.

14. The method of claim 1, further comprising:
receiving, by at least one of the normalization processor, the one or more software development kits, and the one or more web modules, data characterizing another activity related to the topic by the individual;
sorting, by an application programming interface within the computing server, the data characterizing another activity according to topic and activity;
obtaining, by the at least one data processor and from the database, another weight associated with the another activity;
modifying, by the least one data processor and based on the another weight, the score for the individual;
generating, by the at least one data processor and based on the score, a new summary document for the individual, the new summary document displaying the updated score and data characterizing at least the activity and the another activity by the individual; and
sending, by the at least one data processor and via a communication network, the new summary document to the computing device of the entity, the computing device of the entity configured to display the new summary document on the graphical user interface.

15. The method of claim 14, wherein the new summary document is displayed on the graphical user interface of the computing device of the entity in real-time, the real-time characterizing a minimal time difference between a first time when the data characterizing another activity is received and a second time when the new summary document is displayed on the graphical user interface of the computing device of the entity.

16. The method of claim 1, wherein at least one of the normalization processor, the one or more software development kits, and the one or more web modules receives the data characterizing the activity related to the topic by the individual immediately after the activity occurs.

17. The method of claim 16, further comprising:
monitoring, by the at least one data processor, time elapsed since the computing server receives the data characterizing the activity;
comparing, by the at least one data processor, the time elapsed since the computing server receives the data characterizing the activity with a threshold value specific to the activity;
decrementing, by the at least one data processor, the score when the time elapsed since the computing server receives the data characterizing the activity is less than the threshold value; and
sending, by the at least one data processor and via a communication network, the decremented score to the computing device of the entity, the computing device configured to display the decremented score on the graphical user interface.

18. The method of claim 17, wherein the at least one data processor receives the threshold value specific to the activity from the database in order to perform the comparing, the database storing a plurality of threshold values, each threshold value of the plurality of threshold values being specific to a corresponding activity of a plurality of activities that are possible by attendees of an event.

19. The method of claim 2, further comprising:
sending, by the at least one data processor and via a communication network, at least one of the score and the summary document to at least one of a marketing automation application and a customer relationship management application.

20. A non-transitory computer program product storing instructions that, when executed by at least one programmable processor, cause the at least one programmable processor to perform operations comprising:
receiving, at a computing device of an entity, a score for an individual from a computing server connected to the computing device of the entity via a communication network, the score generated by the computing server based on a weight associated with an activity that is associated with the individual and is related to a topic; and
displaying, on a graphical user interface of the computing device of the entity, the score along with scores of other individuals.

21. The non-transitory computer program product of claim 20, wherein:
the entity has a marketing interest in the event; and
the individual is an event attendee of the event.

22. A method comprising:
receiving, by a computing device operated by an event attendee of an event, data characterizing activity related to a topic by the event attendee; and
sending, by the computing device operated by the event attendee and via a first communication network, the data characterizing the activity related to the topic to a computing server connected to the computing device operated by the event attendee, the computing server obtaining a weight associated with the activity from a database of the computing server, the computing server generating a score for the event attendee based on the weight, the computing server sending a data characterizing a recommendation regarding the event attendee based on the score to a computing device of an entity having a marketing interest in the event.

23. The method of claim 22, wherein the computing device of the entity is connected to the computing server via a second communication network.

24. The method of claim 23, wherein the first communication network is same as the second communication network.

25. The method of claim 23, wherein the first communication network is different from the second communication network.

26. The method of claim 22, wherein the computing server generates the data characterizing the recommendation before sending the recommendation to the computing device of the entity having a marketing interest in the event, the computing server generating the data characterizing the recommendation when the score is more than a predetermined threshold value.
